(19) United States
(12) Patent Application Publication
(10) Pub. No.: US 2014/0198814 A1
(43) Pub. Date: Jul. 17, 2014

(54) WAVELENGTH MODULATION HETERODYNE LIGHT SOURCE

(71) Applicant: NATIONAL CENTRAL UNIVERSITY, Jhongli City (TW)

(72) Inventors: Ju-Yi LEE, Jhongli City (TW); Yu-Che CHUNG, Jhongli City (TW)

(73) Assignee: National Central University, Jhongli City (TW)

(21) Appl. No.: 13/776,151

(22) Filed: Feb. 25, 2013

(30) Foreign Application Priority Data
Jan. 11, 2013 (TW) 102101182

(51) Int. Cl. H01S 3/00

(52) U.S. Cl. CPC H01S 3/0085
USPC 372/27

(57) ABSTRACT

The present invention discloses a wavelength modulation heterodyne light source, which comprises: a modulation unit, a wavelength modulated light source and a birefringent crystal. The modulation unit produces a triangular or sine wave modulating signal, and transmits the modulating signal to the wavelength modulated light source to generate a wavelength modulated light signal, then the modulated light signal is refracted by the birefringent crystal with two different optical paths caused by the two different refractivity of the crystal to generate a heterodyne light. With the application of the present invention, the heterodyne light source can be made to a relatively small size and save much cost compared with known heterodyne light sources at present.

### BACKGROUND OF THE INVENTION

1. Technical Field

The present invention relates to wavelength modulation heterodyne light sources with wavelength modulated light sources, and more particularly, to a wavelength modulation heterodyne light source with a wavelength modulated light source and a birefringent crystal.

2. Description of Related Art

The basic principle of heterodyne light is that: heterodyne light is produced by means of mutual interference of two light beams or by causing a frequency change to a light source in an electro-optical, acousto-optical, or mechanical manner. A light source of heterodyne light has to exhibit a high degree of coherence typical of a laser light, for example, and to receive signal light and reference light simultaneously. The frequency of the reference light approximates to the frequency of the signal light, such that a beat frequency signal is formed by means of the reference light and the signal light on a photosensitive surface of a photoelectric probe and is received in the form of heterodyne light.

However, the conventional mechanical ways of producing heterodyne light require a rotational wave plate or a rotational optical grating, both of which modulate the frequency of a light source by mechanical motion and intermittent passage. The stability and response speed of modulating the frequency of a light source in the aforesaid mechanical manner is subjected to great limitations. As a result, the aforesaid mechanical ways of producing heterodyne light no longer apply to heterodyne light production; instead, heterodyne light production nowadays is controlled mostly by electrical means of electro-optical, acousto-optical, or magnetic field-based control signals.

The electrical means of producing heterodyne light can thus be usually divided into three categories, namely Zeeman laser modulation, electro-optical modulation, and acousto-optical modulation.

Zeeman laser modulation involves producing heterodyne light by Zeeman effect and entails applying a magnetic field to a laser generator so as to modulate light emitted from a laser source and thereby produce heterodyne light. Zeeman laser modulation exhibits higher stability and higher response speed than the aforesaid mechanical ways of producing heterodyne light. However, Zeeman laser modulation has its drawbacks, that is, Zeeman laser is expensive and power-inefficient.

Electro-optical modulation involves producing heterodyne light by modulating a light source by means of electro-optical crystal and entails applying a controllable electric field to the electro-optical crystal, such that a vertical polarized light and a horizontal polarized light which are penetrating the electro-optical crystal undergo frequency shift and thereby produce heterodyne light. Likewise, electro-optical modulation has a drawback, that is, it incurs high costs.

And acousto-optical modulation entails guiding a portion of the light generated from a light source to an acousto-optical modulator, sending a soundwave signal or ultrasonic signal from a controllable audio signal source to the acousto-optical modulator, and the frequency of the light is modulated by the acousto-optical modulator in the presence of pressure fluctuation caused by the sound wave signal or ultrasonic signal. As regards its major drawbacks, acousto-optical modulation requires bulky equipment and a plethora of components, necessitates a large required space, and thus the application of acousto-optical modulation is quite limited.

Accordingly, it is imperative to produce heterodyne light at low costs, with small-sized equipment, and by modulating the frequency of a light source in a way characterized by high stability and high response speed.

### SUMMARY OF THE INVENTION

A wavelength modulation heterodyne light source with a wavelength modulated light source according to the present invention comprises a modulation unit, a wavelength modulated light source, and a birefringent crystal. Implementation of the present invention enables the wavelength modulation heterodyne light source to fulfill the goals of miniaturization and cost reduction.

In order to achieve the above and other objectives, the present invention provides a wavelength modulation heterodyne light source with a wavelength modulated light source, comprising: a modulation unit for generating and transmitting a current modulating signal; the wavelength modulated light source, comprising: a light source; and a modulator for receiving the current modulating signal and controlling the light source to emit a wavelength modulated light, wherein the wavelength modulated light comprises a vertical polarized light and a horizontal polarized light; and a birefringent crystal for receiving the wavelength modulated light and producing an optical path difference between the vertical polarized light and the horizontal polarized light by different refractive indexes to thereby emit a heterodyne light.

Implementation of the present invention at least involves the following inventive steps:

1. Reduce the volume of the wavelength modulation heterodyne light source.

2. Reduce the costs of the wavelength modulation heterodyne light source.

3. Enhance the stability of heterodyne light.

Hereinafter, the features and advantages of the present invention will be described in detail so that anyone skilled in the art can appreciate the technical disclosure of the present invention and practice the present invention accordingly, and so that the objectives and advantages of the present invention can be readily understood by anyone skilled in the art upon reviewing the disclosure, claims, and attached drawings of the present invention.

### BRIEF DESCRIPTION OF THE SEVERAL VIEWS OF THE DRAWINGS

The invention as well as a preferred mode of use and advantages thereof will be best understood by referring to the following detailed description of illustrative embodiments in conjunction with the accompanying drawings, wherein:

FIG. 1 is a schematic view of a wavelength modulation heterodyne light source with a wavelength modulated light source according to an embodiment of the present invention.

FIG. 2 is a schematic view of a wavelength modulated light source according to an embodiment of the present invention.

FIG. 3 is a schematic view of another wavelength modulation heterodyne light source with a wavelength modulated light source according to another embodiment of the present invention.

### DETAILED DESCRIPTION OF THE EMBODIMENTS OF THE INVENTION

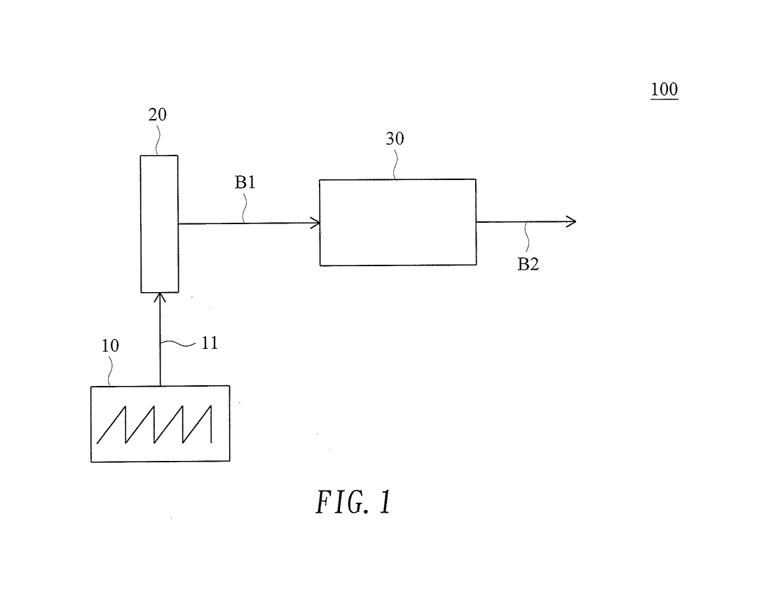

Please refer to FIG. 1, in an embodiment of the present invention, a wavelength modulation heterodyne light source 100 with a wavelength modulated light source 20 comprises a modulation unit 10, the wavelength modulated light source 20, and a birefringent crystal 30, wherein the wavelength modulated light source 20 further comprises a light source 21 and a modulator 22.

The modulation unit 10 generates and transmits a current modulating signal 11. The current modulating signal 11 generated and transmitted by the modulation unit 10 can be a triangular wave or a sine wave. The modulation unit 10 transmits the current modulating signal 11 thus generated to the wavelength modulated light source 20 at the next level for undergoing modulation.

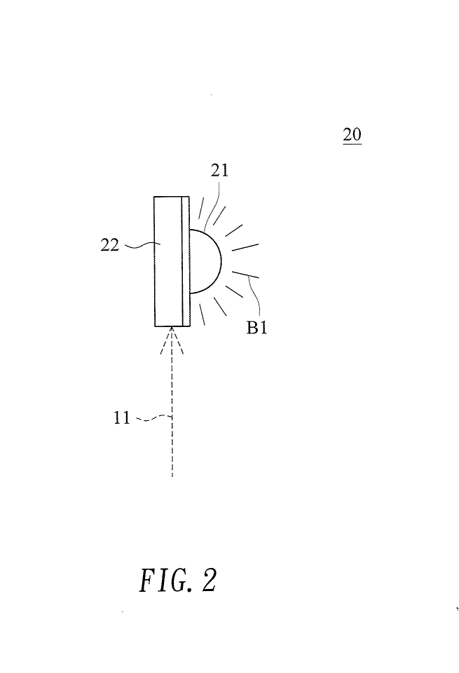

Referring to FIG. 2, the wavelength modulated light source 20 comprises the light source 21 and the modulator 22. The light source 21 emits an initial reference light ray of the wavelength modulation heterodyne light source 100 of the present invention. The light source 21 is a coherent laser generator or a laser diode which is readily available, small-sized, and capable of emitting coherent light in a stable manner, and incurs low costs.

Referring to FIG. 1 and FIG. 2, the modulator 22 of the wavelength modulated light source 20 not only receives the current modulating signal 11 from the modulation unit 10, but also controls the frequency of the light emitted from the light source 21 in accordance with the waveform of the current modulating signal 11 received so as to transmit a wavelength modulated light B1 of time-dependent frequency and wavelength. The wavelength modulated light B1 comprises a vertical polarized light and a horizontal polarized light.

The birefringent crystal 30 receives the wavelength modulated light B1 generated from the wavelength modulated light source 20. Due to different refractive indexes of the birefringent crystal 30, there is an optical path difference between the vertical polarized light and the horizontal polarized light of the wavelength modulated light B1 penetrating the birefringent crystal 30.

That the wavelength of light emitted from the light source 21 varies with time because of the modulator 22, coupled with the optical path difference brought about by the birefringent crystal 30, enables the wavelength modulation heterodyne light source 100, which is equipped with the wavelength modulated light source 20, disclosed in the present invention, and illustrated with FIG. 1, to generate and transmit a heterodyne light B2.

To determine whether a heterodyne light signal is present, it is feasible to dispose a polarizer and a light receiver on an optical path of the heterodyne light B2, such that the light receiver can capture the heterodyne light B2 to obtain the heterodyne light signal. The subsequent application of the heterodyne light B2 entails adding an interferometer or a sensor to the optical path of the heterodyne light B2 to thereby render heterodyne light available.

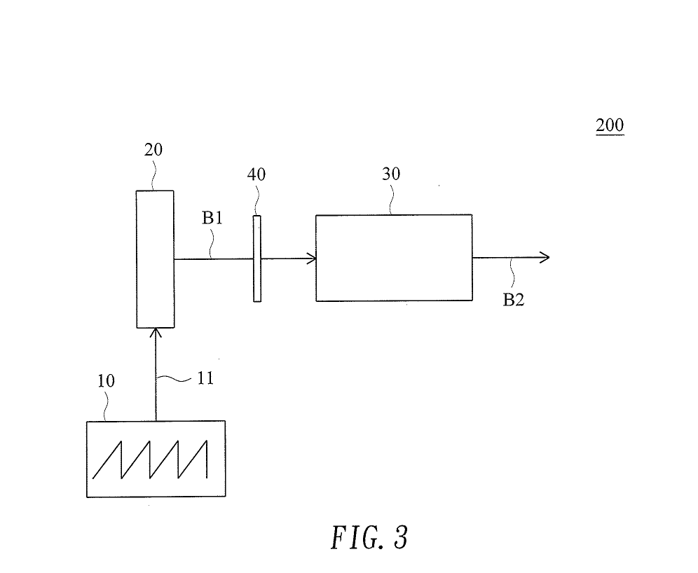

Referring to FIG. 3, there is shown a schematic view of a wavelength modulation heterodyne light source 200 with the wavelength modulated light source 20 according to another embodiment of the present invention. The wavelength modulation heterodyne light source 200 is implemented by equipping the wavelength modulation heterodyne light source 100 shown in FIG. 1 with a polarizer 40.

The polarizer 40 is disposed on the optical path of the wavelength modulated light B1 and adapted to capture a polarized light of the wavelength modulated light B1 in one polarized direction. For instance, if the wavelength modulated light B1 is initially a non-polarized light, the polarizer 40 can be disposed on the optical path to turn the non-polarized light passing through the polarizer 40 into a polarized light. In doing so, light incident on the birefringent crystal is the polarized light.

The embodiments described above are only provided to demonstrate the features of the present invention so that those skilled in the art can understand the contents disclosed herein and implement the present invention accordingly. The embodiments are not intended to limit the scope of the present invention, which is defined only by the appended claims. Therefore, all equivalent modifications or alterations made without departing from the spirit of the present invention should fall within the scope of the claims.

What is claimed is:

1. A wavelength modulation heterodyne light source with a wavelength modulated light source, comprising:
a modulation unit for generating and transmitting a current modulating signal;
the wavelength modulated light source, comprising:
a light source; and
a modulator for receiving the current modulating signal and controlling the light source to emit a wavelength modulated light, wherein the wavelength modulated light comprises a vertical polarized light and a horizontal polarized light; and
a birefringent crystal for receiving the wavelength modulated light and producing an optical path difference between the vertical polarized light and the horizontal polarized light by different refractive indexes to thereby emit a heterodyne light.

2. The wavelength modulation heterodyne light source of claim 1, wherein the current modulating signal is a triangular wave.

3. The wavelength modulation heterodyne light source of claim 1, wherein the current modulating signal is a sine wave.

4. The wavelength modulation heterodyne light source of claim 1, wherein the light source is a laser diode.

5. The wavelength modulation heterodyne light source of claim 1, further comprising a polarizer disposed on an optical path of the wavelength modulated light and adapted to capture a polarized light of the wavelength modulated light in a polarized direction.
